(19) United States
(12) Patent Application Publication
(10) Pub. No.: US 2003/0040284 A1
(43) Pub. Date: Feb. 27, 2003

(54) Method and apparatus of retransmitted data combination

(76) Inventor: Masanori Sato, Tokyo (JP)

Correspondence Address: COOPER & DUNHAM LLP, 1185 Avenue of the Americas, New York, NY, 10036, US

(21) Appl. No.: 09/995,073

(22) Filed: Nov. 27, 2001

(30) Foreign Application Priority Data
Dec. 5, 2000 (JP) P2000-369511

(51) Int. Cl. H04B 1/00; H04B 7/00

(52) U.S. Cl. 455/70; 455/412; 455/137; 455/226.1

(57) ABSTRACT

An apparatus for combining retransmitted data comprises a buffer for storing received data unfavorably received of received data received by a radio receiver and converted to a base band, a combiner for combining the received data stored in the buffer with retransmitted received data, and a demodulator for demodulating the combined data combined by the combiner, wherein the demodulation is performed after combining the received data stored in the buffer with the retransmitted received data.

### CROSS REFERENCES TO RELATED APPLICATIONS

The present document is based on Japanese Priority Document JP 2000-369511, filed in the Japanese Patent Office on Dec. 5, 2000, the entire contents of which being incorporated herein by reference.

### BACKGROUND OF THE INVENTION

1. Field of the Invention

The present invention relates to a method of retransmitted data combination, and more particularly to a method and an apparatus of retransmitted data combination by storing data if the data is abnormally received, retransmitting the data from a transmission side, and combining the retransmitted data with the abnormally received and stored data on a reception side to obtain received data.

2.Description of Related Art

In conventional packet retransmission, when data (packets) is unsuccessfully received in a receiver at a time of performing packet communications, the unsuccessfully received data is typically retransmitted as means for compensation. This is called “ARQ (Automatic Repeat reQuest).” When a transmission path between a transmitter and a receiver is in poor condition, an error correction technique may be used as well. This is called “hybrid ARQ.” The hybrid ARQ has a plurality of types which include a method of increasing the probability of allowing demodulation by combining retransmitted data with data unsuccessfully received last time in a receiver.

FIG. 1 illustrates a basic concept of a data retransmission. In FIG. 1, a transmission side transmits data and a reception side reports to the transmission side whether the received data is normally or abnormally received. Upon receipt of the notification of abnormal reception (that is, a notification for retransmission), the transmission side retransmits to the reception side the data which could not be normally received.

FIG. 2 illustrates a data retransmission process. In FIG. 2, a transmission side serially transmits transmission data as data D1, D2, D3, D4, . . . . A reception side receives the data as the data D1, D2, D3, D4 . . . . Assuming, for example, that the data D1, D2 is successfully received but the data D3 is unsuccessfully, the reception side stores the data D3 in a buffer and transmits a retransmission request to the transmission side. The transmission side retransmits the data D3 after a predetermined time period, in this case after the transmission of the data D4. The reception side receives the retransmitted D3 data, and then combines the retransmitted D3 data with the previously stored D3 data.

In this manner, the data determined as being abnormally received is retransmitted and the retransmitted data is combined with the previously transmitted data to produce the effect of time diversity (gain obtained from a difference in acquired data due to changing states of propagation paths), so that the probability of allowing normal demodulation can be increased as compared with simple modulation of the retransmitted data. However, the receiver needs to include a buffer since the previous data must be held.

FIGS. 3A and 3B illustrate a general flow of conventional data transmission and reception. In FIG. 3 A, transmission data is encoded in an encoder 21, modulated in a modulator 22, and transmitted to a reception side through a propagation path 50. On the reception side, the received data is demodulated in a demodulator 24, temporarily stored in a buffer 25, and then the stored data is combined with retransmitted data in a combiner 26. In this manner, the buffer is placed between the demodulator 24 and a decoder 27 in a conventional produced data combination method. In FIG. 3A, the number of bits of data at point A before the demodulator 24 (between the propagation path 50 and the demodulator 24) and the number of bits at point B after the demodulator 24 (between the demodulator 24 and the buffer 25) vary according to a modulation method. A table in FIG. 3B shows the numbers of bits at the points before and after the demodulator 24 (at the point A and the point B). Before the demodulation, the number of bits representing one symbol is always two since data is transmitted as binary data. After the demodulation, however, the number of bits varies depending on a modulation method. Specifically, data representing one symbol is two bit digital data in QPSK, three in 8 QAM, four in 16 QAM, and six in 64 QAM. Thus, as the order in multilevel modulation is higher, the number of bits to be stored in the buffer 25 is increased. It should be noted that the modulation methods herein referred to are illustrative. In multilevel modulation, the size of data at the point B is changed.

FIG. 4 illustrates a transmitter/receiver for performing retransmitted data combination in the prior art. In FIG. 4, the transmitter/receiver comprises an antenna 11 for transmitting and receiving signals, a duplexer 12 for switching between reception and transmission of radio waves from the antenna 11, a receiver 13 for conversion from a reception RF frequency to a base band frequency, a transmitter 14 for conversion from a base band frequency to a transmission RF frequency, an encoder 21 for encoding transmission data, a modulator 22 for converting a bit string to be transmitted into transmission symbols, a phase corrector 23 for correcting a phase of received data, a demodulator 24 for converting received symbols to a bit string, a buffer 25 for storing received symbols, a combiner 26 for combining the received data stored in the buffer 25 with retransmitted data, and a decoder 27 for decoding demodulated data. The transmitter/receiver further comprises a DSP 31 for controlling a base band, processing protocols and the like, a ROM 32, a RAM 33, a CPU 34, an I/O controller 35 for controlling connection with an external interface, and external interfaces such as a display 41, a key input device 42, a microphone 43, and a speaker 44.

Since the transmitter/receiver has the same configuration as a typical transmitter/receiver except that it includes the phase corrector 23 for correcting a phase of data, the buffer 25 for storing data, and the combiner 26 for combining retransmitted data with stored data, detailed description thereof is omitted. The phase corrector 23, the buffer 25, and the combiner 26 are described later.

With growing demand for data communications, a faster interface is needed. For a modulation method, transition is under way from a phase modulation method typified by conventional QPSK (quadrature phase shift keying) to multilevel modulation such as 8 QAM (quadrature amplitude modulation), 16 QAM, or 64 QAM. FIGS. 5A to 5C illustrate differences in modulation among the QPSK, 8 QAM, and 16 QAM. FIG. 5A shows arrangement of signal points in the QPSK, FIG. 5B shows arrangement of signal points in the 8 QAM, and FIG. 5C shows arrangement of signal points in the 16 QAM. In FIGS. 5A to 5C, for one transmission (reception) symbol (I+jQ), two bit digital data is modulated in the QPSK, three in the 8 QAM, and four in the 16 QAM. When this is represented in a general formula for M QAM (M is equal to 8, 16, 64 or the like), Log (M) bit digital data is modulated on orthogonal carrier waves I, Q. In other words, with a higher order in multilevel modulation method, a higher bit digital data can be transmitted on carrier waves. In these cases, amplitude modulation of information is also performed to provide high transfer efficiency of digital data per a symbol (modulated data on I, Q), thereby making it possible to provide a fast interface.

The conventional method of retransmitted data combination shown in FIGS. 3 and 4, however, has a problem of an increased size of the buffer for storing the previous data to perform retransmitted data combination as the order is higher in a multilevel modulation method, as described above.

In addition, since demodulation (conversion from symbols to digital data) for multilevel modulation typically involves a nonlinear element, combination of data after the demodulation cannot lead to improved accuracy of demodulation and decoding due to the nonlinearity.

### SUMMARY OF THE INVENTION

It is an aspect of the present invention to provide a method and an apparatus for combining retransmitted data, which are capable of significantly reducing the size of a buffer in a receiver and improving accuracy of demodulation and decoding.

To achieve the aforementioned aspect, the present invention provides a method configured to comprise the steps of: storing received data determined as being abnormally received of received data received by a radio receiver and converted to a base band; combining the stored received data with retransmitted received data; and then demodulating the combined data.

According to the method of the present invention, the received data is stored after it is subjected to phase correction, the retransmitted received data is phase-corrected, and then the phase-corrected and stored received data is combined with the retransmitted and phase-corrected received data.

In addition, the present invention also provides a method configured to comprise the steps of: receiving a radio signal by an antenna, performing RF processing on the radio signal by a receiver for conversion to a base band frequency, and then determining whether the received data is retransmitted received data; when the received data is not the retransmitted received data, demodulating and decoding the received data when the data is not abnormal, or abandoning the data after decoding and storing the received data in storing means when the received data is abnormal data; when the received data is the retransmitted received data, combining the retransmitted received data with abnormal data stored in the storing means last time, and demodulating and decoding the combined data; and determining whether the decoded data is normal, and ending processing when the decoding is normally performed, or abandoning the decoded data and storing the received data in the storing means when the decoding is abnormally performed.

According to the method of the present invention, the received data is stored after it is subjected to phase correction, the retransmitted received data is phase-corrected, and then the phase-corrected and stored received data is combined with the retransmitted and phase-corrected received data.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 illustrates data retransmission;

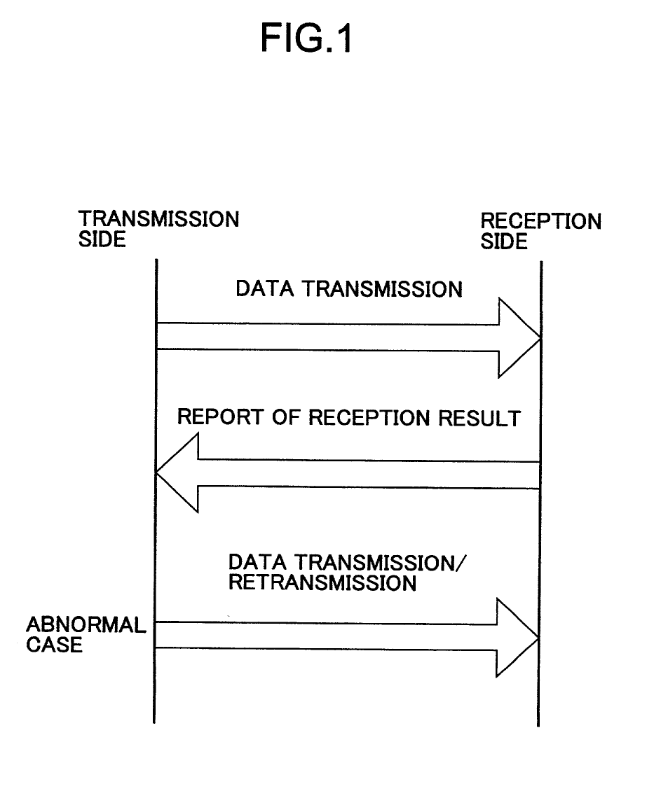

FIG. 2 illustrates a data retransmission process;

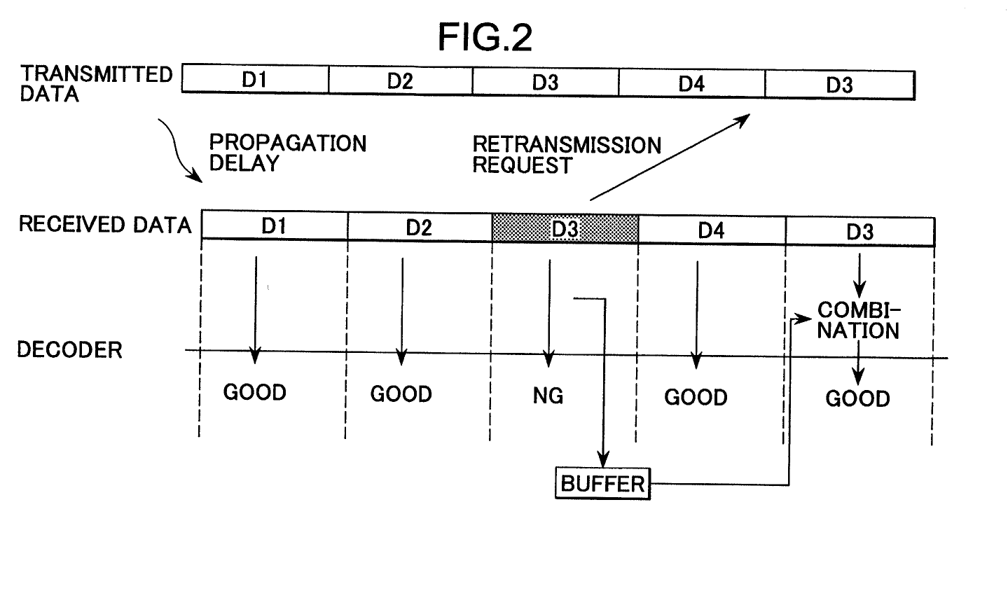

FIGS. 3A and 3B illustrate a general flow of data transmission and reception in the prior art;

FIG. 4 illustrates a transmitter/receiver for performing retransmitted data combination in the prior art;

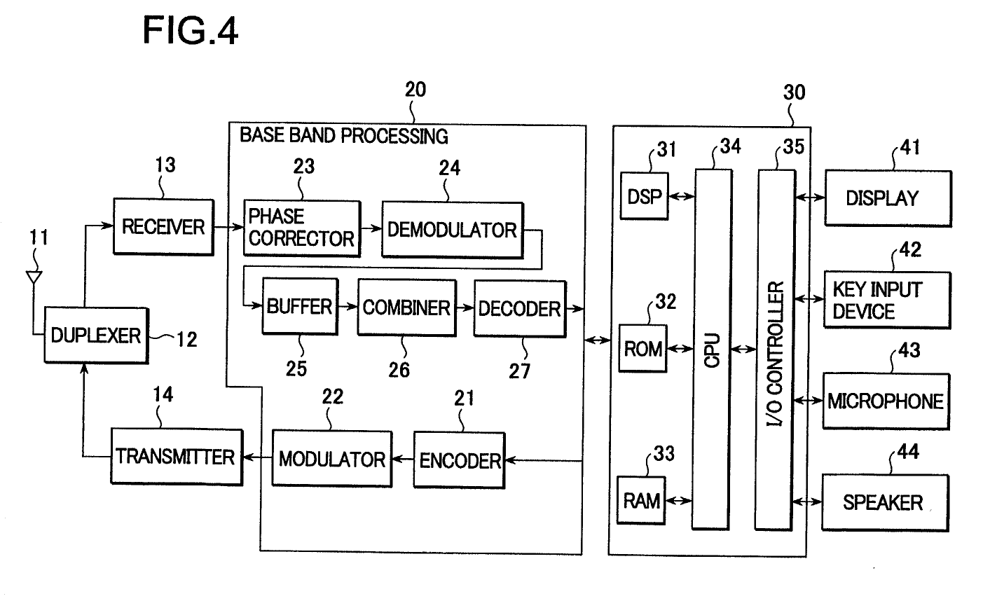

FIGS. 5A to 5C illustrate differences in modulation among the QPSK, 8 QAM, and 16 QAM;

FIG. 6 illustrates a general flow of data transmission and reception according to an embodiment of the present invention;

FIG. 7 illustrates a transmitter/receiver for performing retransmitted data combination in the present invention;

FIG. 8 is a flow chart illustrating a process of combining abnormal data with retransmitted data in the present invention;

FIG. 9 illustrates a combination process in the present invention; and

FIG. 10 is a diagram for explaining the correspondence between received symbols and an output bit string in Gray codes.

### DESCRIPTION OF THE PREFERRED EMBODIMENT

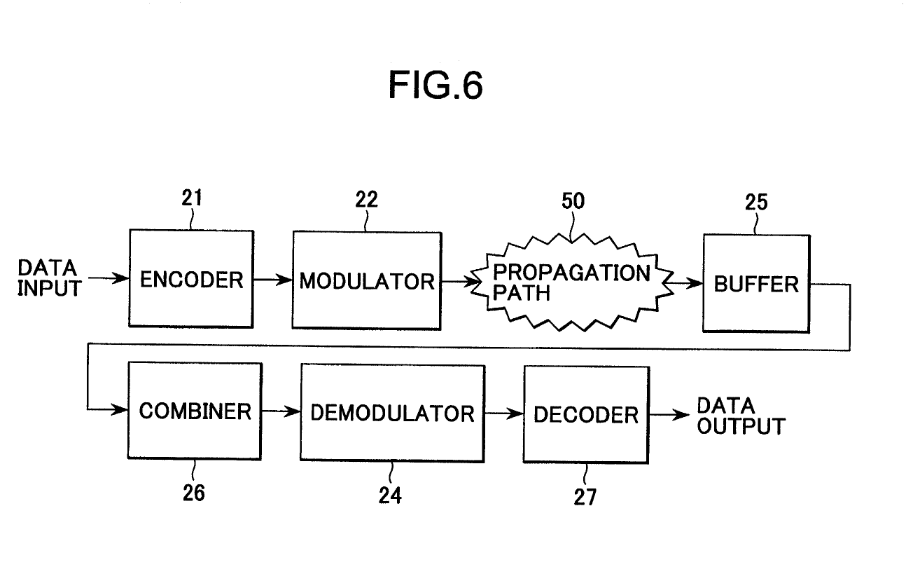

FIG. 6 illustrates a general flow of data transmission and reception according to an embodiment of the present invention. In FIG. 6, transmission data is encoded in an encoder 21, modulated in a modulator 22, and transmitted to a reception side through a propagation path 50. On the reception side, the received data is temporarily stored in a buffer 25, and then the stored data is combined with retransmitted data in a combiner 26, and demodulated in a demodulator 24. In this manner, the buffer 25 is provided before the demodulator 24 in the retransmitted data combination method of the present invention. Such a configuration enables a significant reduction in the size of the buffer. In addition, accuracy of demodulation and decoding can be improved, as will be described later.

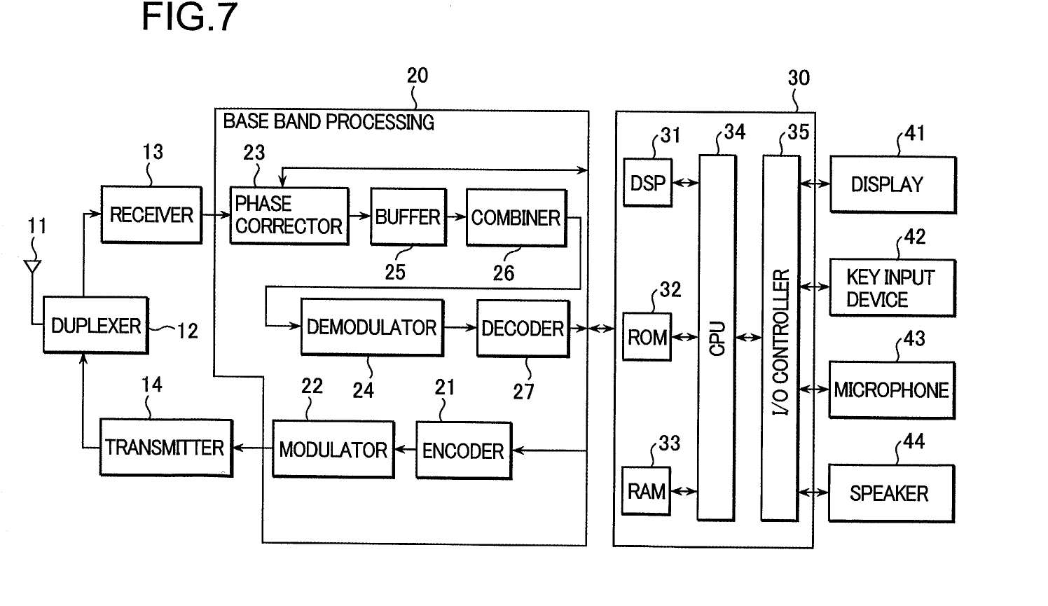

FIG. 7 illustrates a transmitter/receiver for performing retransmitted data combination in the present invention. Since the components in FIG. 7 are identical to those in the conventional configuration except for the order of a phase corrector 23, the demodulator 24, the buffer 25, and the combiner 26, detailed description of the other components is omitted. The buffer 25 and the combiner 26 placed before the demodulator 24 are characteristic of the present invention in FIG. 7. Such placement of the buffer 25 before the demodulator 24 can achieve the aspect of the present invention.

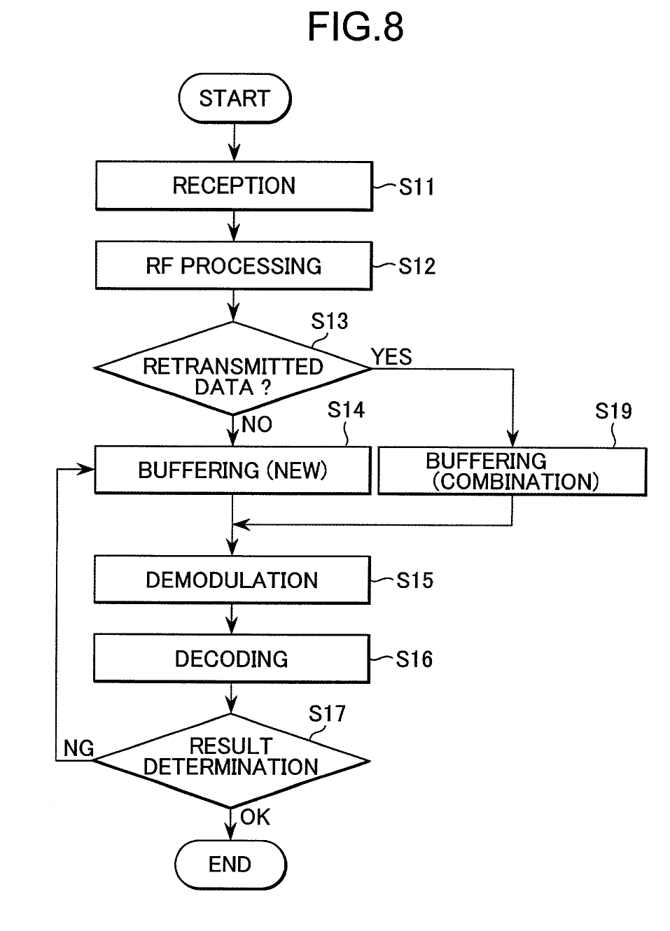

FIG. 8 is a flow chart illustrating a process of combining abnormal data with retransmitted data in the present invention. In FIG. 8, reception data is received in an antenna 11 (step S11), and subjected to RF processing in a receiver 13 for conversion to a base band frequency (step S12). The base band frequency signal is sent to a control section 30. Then, a retransmission determining unit included in the control section 30 determines whether the received data (in frames) is retransmitted received data (step S13). If not, the data is stored in the buffer 25 (step 14), and processing in the combiner 26 is skipped. The data is demodulated (step S15) and is decoded at step S16. If the decoding is determined as being normally performed at step S17, the processing is ended. If the decoding is determined as being abnormal, the decoded data is abandoned and the received data stored in the buffer 25 is held.

On the other hand, if the received data is determined as being the retransmitted received data at step S13, the data is combined with abnormal data stored last time in the buffer 25 (step S19). The resultant data is demodulated (converted from symbols to a bit string) (step S15), then decoding is performed (step S16), and judgment on the result is carried out (step S17). If the decoding is normal, the processing is ended, or if not, the decoded data is abandoned and the received data is stored in the buffer 25. The determination at step S17 is performed with a determination flag (typically by CRC: Cyclic Redundancy Check, Check Sum or the like) included in a frame.

Next, a comparison is made between the storage of received data in the buffer 25 before demodulation according to the present invention and the storage of received data in the buffer 25 after demodulation in the prior art. When received data is stored in the buffer 25 provided after demodulation as in the prior art, the size of the buffer is increased depending on a modulation method in multilevel modulation. According to the present invention, however, a small buffer size is advantageously sufficient at all times regardless of a modulation method since received data is stored in the buffer 25 before demodulation.

Table 1 shows the relationship between modulation methods and buffer sizes. In Table 1, buffer sizes required when one frame consists of 100 symbols are shown, by way of example.

TABLE 1

| | Conventional | Buffer Size of the |
|---|---|---|
| | Buffer Size | Present Invention |
| Modulation Method | (Symbols) | (Symbols) |
| QPSK | 100 * 2 = 200 | 100 * 2 = 200 |
| 8 PSK, 8 QAM | 100 * 3 = 300 | 100 * 2 = 200 |
| 16 PSK, 16 QAM | 100 * 4 = 400 | 100 * 2 = 200 |
| 32 PSK, 32 QAM | 100 * 5 = 500 | 100 * 2 = 200 |
| 64 PSK, 64 QAM | 100 * 6 = 600 | 100 * 2 = 200 |

It should be noted that the above modulation methods are absolutely illustrative, and actually, only some of them are practically used. It is thought that, 64 PSK, for example, will not be used in practice for the time being. As seen from Table 1, in the present invention, the size of the buffer need not be changed even when multilevel modulation is used, by holding data before demodulation.

The multilevel modulation involves modulation of information with amplitude values, and demodulation therefor often includes nonlinear processing (processing such as obtaining absolute values). The nonlinear processing results in abandonment of some of the information, which means that the demodulation causes a reduction in the amount of the information to some extent. Thus, accuracy of demodulation and decoding can be improved by combining data before some of the information thereof is lost, that is, data before demodulation, as compared with combination of data after demodulation. With attention focused on this point, the present invention is configured to perform received data combination in a stage before demodulation.

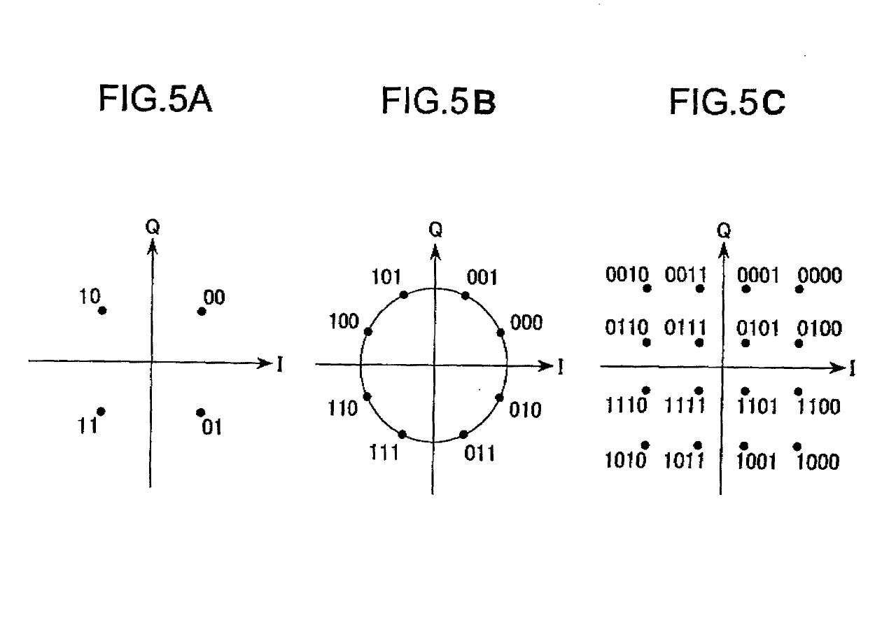

In the following, the method of data combination before demodulation is described in the present invention, and a difference between the method of the present invention and the conventional combination method is also described. The following description is made assuming that input data has been modulated with 16 QAM, but the description is similarly applied to 8 QAM, 64 QAM and the like as a matter of course. Modulated symbol points are typically arranged as shown in FIGS. 5A-5C described above. In FIGS. 5A-5C, Gray codes are used in mapping of a bit string. The Gray coding is most widely used under present circumstances in view of easy demodulation and characteristics, although other methods are possibly employed. Now, description is made for a typical method of obtaining an original bit string from data (symbols) on I, Q arranged as shown in FIGS. 5A-5C, and for enhanced demodulation efficiency by combining the data thus obtained.

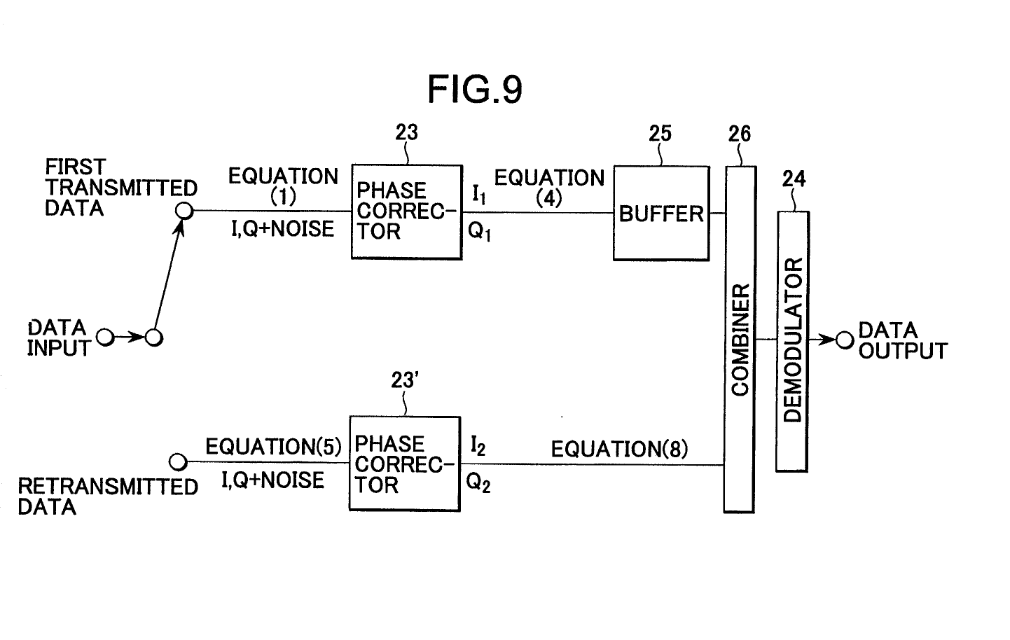

FIG. 9 illustrates a combination process in the present invention. FIG. 9 enlargedly shows only a portion of the transmitter/receiver in FIG. 7 including the phase corrector 23, the buffer 25, the combiner 26, and the demodulator 24, for illustrating the process of combining retransmitted data with data which was determined as being abnormal and stored in the buffer 25.

In FIG. 9, data received in the receiver 13 is first subjected to phase correction in the phase corrector 23. This operation is performed to remove the effect of fading in a propagation path. Given that data including no noise received from the receiver 13 is I+jQ, fading noise in a propagation path is α₁+jβ₁, and thermal noise is n₁ᵢ+jn_{1q}, received data before phase correction can be represented as equation (1):

(I+jQ)(α₁+jβ₁)+n₁ᵢ+iq (1)

Assuming that the phase correction is ideally performed, the phase correction can be realized by multiplying the received data by the conjugate of the fading noise, and data after the phase correction can be obtained by equation (2):

$$( ( I + jQ ) ( {α}_{1} + j {β}_{1} ) + {n}_{1 i} + {jn}_{1 q} ) ( {α}_{1} - j {β}_{1} ) = ( I + jQ ) ( {α}_{1}^{2} + {β}_{1}^{2} ) + ( {n}_{1 i} + {jn}_{1 q} ) ( {α}_{1} - j {β}_{1} ) \qquad ( 2 )$$

When the part corresponding to the noise of the second term is replaced with mᵢᵢ+jm_{1q}, received data before demodulation is represented by equation (3):

$$( {α}_{1}^{2} + {β}_{1}^{2} ) ( I + jQ ) + {m}_{1 i} + {jm}_{1 q} = ( {α}_{1}^{2} + {β}_{1}^{2} ) I + {m}_{1 i} + j \{ ( {α}_{1}^{2} + {β}_{1}^{2} ) Q + {jm}_{1 q} \} \qquad ( 3 )$$

The real part is represented by I1 and the imaginary part is represented by Q1 in equation (3) to obtain the following equation (4):

$$I1 = ( {α}_{1}^{2} + {β}_{1}^{2} ) I + {m}_{1 i} \\ Q1 = ( {α}_{1}^{2} + {β}_{1}^{2} ) Q + {m}_{1 q} \qquad ( 4 )$$

Similarly, for retransmitted data, in a phase corrector 23′ in FIG. 9, received data before phase correction can be represented as equation (5) given that data including no noise received from the receiver 13 is I+jQ, fading noise in a propagation path is α₂+j₂, and thermal noise is n₂ᵢ+jn_{2q}:

(I+jQ)(α₂+jβ₂)+n₂ᵢ+jn_{2q} (5)

Data after the phase correction can similarly be obtained as equation (6):

$$( ( I + jQ ) ( {α}_{2} + j {β}_{2} ) + {n}_{2 i} + {jn}_{2 q} ) ( {α}_{2} - j {β2}_{2} ) = ( I + jQ ) ( {α}_{2}^{2} + {β}_{2}^{2} ) + ( {n}_{2 i} + {jn}_{2 q} ) ( {α}_{2} - j {β}_{2} ) \qquad ( 6 )$$

When the part corresponding to the noise of the second term is replaced with m₂ᵢ+jm_{2q}, received data before demodulation is represented by equation (7):

$$( {α}_{2}^{2} + {β}_{2}^{2} ) ( I + jQ ) + {m}_{2 i} + {jm}_{2 q} = ( {α}_{2}^{2} + {β}_{2}^{2} ) I + {m}_{2 i} + j \{ ( {α}_{2}^{2} + {β}_{2}^{2} ) Q + {jm}_{2 q} \} \qquad ( 7 )$$

The real part is represented by I2 and the imaginary part is represented by Q2 in equation (7) to obtain the following equation (8):

$$I2 = ( {α}_{2}^{2} + {β}_{2}^{2} ) I + {m}_{2 i} \\ Q2 = ( {α}_{2}^{2} + {β}_{2}^{2} ) Q + {m}_{2 q} \qquad ( 8 )$$

Next, data (a bit string) obtained by combining the first data with the retransmitted data is derived. While various methods are known for combining the first data with the retransmitted data, detailed description thereof is omitted since the methods are well-known techniques.

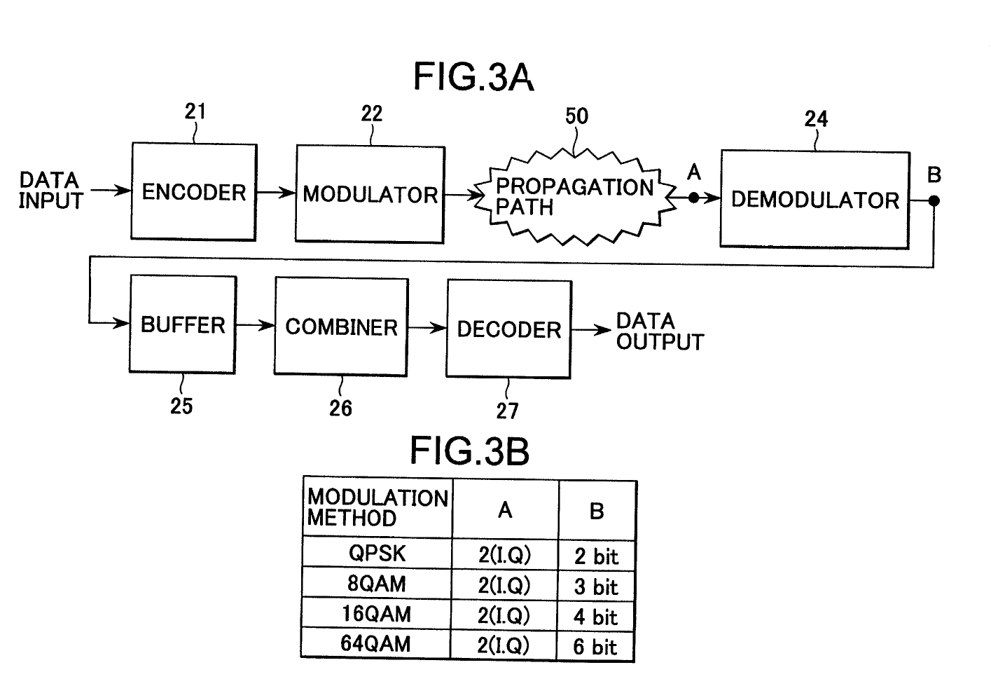

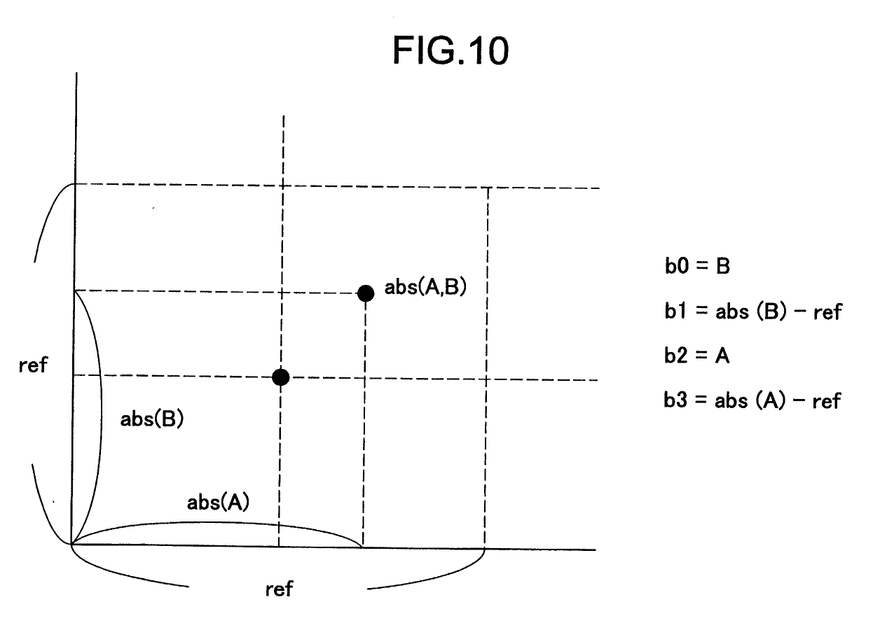

FIG. 10 is a diagram for explaining the correspondence between a received symbol and an output bit string in the Gray codes. In FIG. 10, if a received symbol (I+jQ) in FIG. 3 is represented by (A+jB), the relationship between the received symbol A+jB and an output bit string b0b1b2b3 is represented by the following equation (9):

b0=B

b1=abs(B)−ref

b2=A

b3=abs(A)−ref (9)

where “ref” is a threshold value for selecting bits in each quadrant in demodulation for QAM. Since equation (9) is a known equation, detailed description thereof is omitted here.

When equation (9) is used to determine combined data when data combination before demodulation is performed in the present invention, Ip and Qp in Ip+jQp are obtained as follows:

$$Ip = ( {α}_{1}^{2} + {β}_{1}^{2} ) I + {m}_{1 i} + ( {α}_{2}^{2} + {β}_{2}^{2} ) I + {m}_{2 i} = \{ ( {α}_{1}^{2} + {β}_{1}^{2} ) + ( {α}_{2}^{2} + {β}_{2}^{2} ) \} I + {m}_{1 i} + {m}_{2 i} \\ Qp = ( {α}_{1}^{2} + {β}_{1}^{2} ) Q + {m}_{1 q} + ( {α}_{2}^{2} + {β}_{2}^{2} ) Q + {m}_{2 q} = \{ ( {α}_{1}^{2} + {β}_{1}^{2} ) + ( {α}_{2}^{2} + {β}_{2}^{2} ) \} Q + {m}_{1 q} + {m}_{2 q} \qquad ( 10 )$$

Next, the bit string b0b1b2b3 obtained by demodulating symbols Ip+jQp when data combination before demodulation is performed in the present invention is determined from equation (9) as the following equation (11):

$$b0 = Qp = \{ ( {α}_{1}^{2} + {β}_{1}^{2} ) + ( {α}_{2}^{2} + {β}_{2}^{2} ) \} Q + {m}_{1 q} + {m}_{2 q} \\ b1 = abs ( Qp ) - ref = abs ( \{ ( {α}_{1}^{2} + {β}_{1}^{2} ) + ( {α}_{2}^{2} + {β}_{2}^{2} ) \} Q + {m}_{1 q} + {m}_{2 q} ) - ref \\ b2 = Ip = \{ ( {α}_{1}^{2} + {β}_{1}^{2} ) + ( {α}_{2}^{2} + {β}_{2}^{2} ) \} I + {m}_{1 i} + {m}_{2 i} \\ b3 = abs ( Ip ) - ref = abs ( \{ ( {α}_{1}^{2} + {β}_{1}^{2} ) + ( {α}_{2}^{2} + {β}_{2}^{2} ) \} I + {m}_{1 i} + {m}_{2 i} ) - ref \qquad ( 11 )$$

In the following, description is made for demonstrating that the aforementioned equation (11) enables demodulation with higher efficiency than the conventional combination method. For that purpose, a bit string b10b11b12b13 obtained by demodulating a received symbol I1+jQ1, and a bit string b20b21b22b23 obtained by demodulating a received symbol I2+jQ2 are determined in the conventional method, and the two bit strings are combined to obtain a combined bit string b0b1b2b3.

First, the bit string b10b11b12b13 obtained by demodulating the received symbol I1+jQ1 is determined as equation (12):

$$b10 = Q1 = ( {α}_{1}^{2} + {β}_{1}^{2} ) Q + {m}_{1 q} \\ b11 = abs ( Q1 ) - ref1 = abs ( ( {α}_{1}^{2} + {β}_{1}^{2} ) Q + {m}_{1 q} ) - ref1 \\ b12 = I1 = ( {α}_{1}^{2} + {β}_{1}^{2} ) I + {m}_{1 i} \\ b13 = abs ( I1 ) - ref1 = abs ( ( {α}_{1}^{2} + {β}_{1}^{2} ) I + {m}_{1 i} ) - ref1 \qquad ( 12 )$$

The bit string b20b21b22b23 obtained by demodulating the received symbol I2+jQ2 is determined by equation (13):

$$b20 = Q2 = ( {α}_{2}^{2} + {β}_{2}^{2} ) Q + {m}_{2 q} \\ b21 = abs ( Q2 ) - ref2 = abs ( ( {α}_{2}^{2} + {β}_{2}^{2} ) Q + {m}_{2 q} ) - ref2 \\ b22 = I2 = ( {α}_{2}^{2} + {β}_{2}^{2} ) I + {m}_{2 i} \\ b23 = abs ( I2 ) - ref2 = abs ( ( {α}_{2}^{2} + {β}_{2}^{2} ) I + {m}_{2 i} ) - ref2 \qquad ( 13 )$$

The sums of corresponding bits in equations (12) and (13) obtained above serve as data after combination in the conventional retransmitted data combination method, which data is obtained as equation (14):

$$b0 = b10 + b20 = ( {α}_{1}^{2} + {β}_{1}^{2} ) Q + ( {α}_{2}^{2} + {β}_{2}^{2} ) Q + {m}_{1 q} + {m}_{2 q} \\ b1 = b11 + b21 = abs ( ( {α}_{1}^{2} + {β}_{1}^{2} ) Q + {m}_{1 q} ) + abs ( ( {α}_{2}^{2} + {β}_{2}^{2} ) Q + {m}_{2 q} ) - ref1 - ref2 \\ b2 = b12 + b22 = ( {α}_{1}^{2} + {β}_{1}^{2} ) I + ( {α}_{2}^{2} + {β}_{2}^{2} ) I + {m}_{1 i} + {m}_{2 i} \\ b3 = b13 + b23 = abs ( ( {α}_{1}^{2} + {β}_{1}^{2} ) I + {m}_{1 i} ) + abs ( ( {α}_{2}^{2} + {β}_{2}^{2} ) I + {m}_{2 i} ) - ref1 - ref2 \qquad ( 14 )$$

When the data after combination represented by equation (11) obtained in the retransmitted data combination method in the present invention is compared with the data after combination represented by equation (14) obtained in the retransmitted data combination method in the prior art, b0 and b2 are the same in both of them. However, b1 and b3 are different from their counterparts. Specifically, in the method as in the present invention in which demodulation is performed after combination, absolute values are obtained after the combination of noise, so that noises m₁ᵢ+jm_{1q}, m₂ᵢ+jm_{2q} are canceled each other if they have opposite polarities. However, in the method as in the prior art in which combination is performed after demodulation, the combination is performed after the calculation of absolute values (abs), so that noises, even with opposite polarities, are not canceled. As a result, remaining components without being canceled serve as noise to affect reception characteristics thereafter. As described above, in the present invention, it can be seen that the noise is canceled and the effect of the noise is reduced by the demodulation after the received symbol combination.

As described above, the multilevel modulation involves amplitude modulation of information, and the demodulation therefor often includes nonlinear processing (processing such as obtaining absolute values). Since the nonlinear processing causes abandonment of some of the information, the demodulation leads to loss of some of the information. Thus, accuracy of demodulation and decoding can be improved by combining data before some of the information thereof is lost, that is, data before demodulation, rather than combining data with some of the information lost.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

What is claimed is:

1. A method of combining retransmitted data, comprising the steps of:
storing received data determined as being abnormally received of received data received by a radio receiver and converted to a base band;
combining said stored received data with retransmitted received data; and
demodulating said combined data.

2. The method of combining retransmitted data according to claim 1, wherein said received data is phase-corrected and then stored, said retransmitted received data is phase-corrected, and then said phase-corrected and stored received data is combined with said retransmitted and phase-corrected received data.

3. A method of combining retransmitted data, comprising the steps of:
receiving a radio signal by an antenna, performing RF processing on the radio signal by a receiver for conversion to a base band frequency, and then determining whether the received data is retransmitted data;
when the received data is not retransmitted received data, demodulating and decoding the received data when the data is not abnormal, and abandoning the data after decoding and storing the received data in a memory when the received data is abnormal data;
when the received data is retransmitted received data, combining the retransmitted received data with abnormal data stored in the memory the last time, and demodulating and decoding the combined data; and
determining whether the decoded data is normal, and ending processing when the decoding is normally performed, and abandoning the decoded data and storing the received data in the memory when the decoding is abnormally performed.

4. The method of combining retransmitted data according to claim 3, wherein:
said received data is phase-corrected and then stored, and
said retransmitted received data is phase-corrected, and then said phase-corrected and stored received data is combined with said retransmitted and phase-corrected received data.

5. A retransmitted data combining apparatus comprising:
a memory for storing received data determined as being abnormally received of received data received by a radio receiver and then converted to a base band;
a combiner for combining said received data stored in said memory with retransmitted received data; and
a demodulator for demodulating said combined data combined by said combiner.

6. The retransmitted data combining apparatus according to claim 5, further comprising a phase corrector for phase-correcting received data, wherein said received data is phase-corrected by said phase corrector and then stored in said memory, and said retransmitted received data is phase-corrected by said phase corrector and then combined with said received data stored in said memory in said combiner.
